(19) United States
(12) Patent Application Publication
(10) Pub. No.: US 2009/0100161 A1
(43) Pub. Date: Apr. 16, 2009

(54) SYSTEM AND METHOD FOR MANAGING COMMUNICATIONS

(75) Inventors: PATRICK JOSEPH O'SULLIVAN, Ballsbridge (IE); Robert Cameron Weir, Westford, MA (US); Edith Helen Stern, Yorktown Heights, NY (US); Barry E. Willner, Briarcliff Manor, NY (US)

Correspondence Address: HOLLAND & KNIGHT, 10 ST. JAMES AVENUE, BOSTON, MA, 02116-3889, US

(73) Assignee: INTERNATIONAL BUSINESS MACHINES CORPORATION, Armonk, NY (US)

(21) Appl. No.: 11/872,126

(22) Filed: Oct. 15, 2007

(51) Int. Cl. G06F 15/173

(52) U.S. Cl. 709/223

(57) ABSTRACT

A method and computer program product for managing interruptions including defining a communication management policy for a plurality of communication channels. Communications on the plurality of communication channels are delivered based upon, at least in part, the communications management policy. Similarly, communications on the plurality of communication channels are rejected based upon, at least in part, the communications management policy.

### TECHNICAL FIELD

This disclosure relates to managing communications and, more particularly, to systems and methods for managing communications across multiple communication channels.

### BACKGROUND

Email, instant messaging, text messaging, as well as other communications systems that exist today have converged to leave consumers of the technologies with less control of when and how they are interrupted. For this reason the suitability for enterprise use of instant messaging systems and other communications metaphors such as SMS (short message service, e.g., text messaging), cellular and voice mail are being debated. One of the reasons for this debate is that interruptions from all these communication systems are stochastic, unplanned, intrusive and distracting. Interruptions by way of mail, instant messaging, text messaging, telephone, calendar invites, e-meetings, voice mail, organizational web conferences, cellular, and so on, are hugely time consuming and are oftentimes a nuisance for those who wish to concentrate on a task, or manage their day in relation to tasks they want to get done. Likewise, managers of teams are oftentimes frustrated with outside interruptions distracting members of their team and wish to manage this.

While the distraction and time consumption are detrimental to productivity and often frustrating, the diversity in communications systems also provide great benefits. For example, in the case of geographically dispersed organizations the multitude of communications systems provide easy collaboration and, at least in some regards, can enhance overall productivity. The problem is, therefore, one of managing the distractions and nuisance arising from excessive communications.

### SUMMARY OF DISCLOSURE

In a first implementation, a method includes defining a communication management policy for a plurality of communication channels. Communications on the plurality of communication channels are delivered based upon, at least in part, the communications management policy. Similarly, communications on the plurality of communication channels are rejected based upon, at least in part, the communications management policy.

One or more of the following features may be included. The plurality of communications channels may include one or more of email, instant messaging, voice communication, and SMS communications. The communication management policy may defined by a third party.

The communication management policy may be based upon, at least in part, one or more of an organizational structure, and a social network defined for a user. The communication management policy may include a plurality of levels of communication permissions. The communication management policy may be based upon, at least in part, one or more of a time-wise schedule, and a communication volume for the plurality of communication channels.

The method may also include defining one or more exceptions to the communication management policy. Furthermore, the method may include notifying a communication sender of a rejected communication.

According to another implementation, a computer program product resides on a computer readable medium having a plurality of instructions stored thereon. When executed by a processor, the instructions cause the processor to perform operations including defining a communication management policy for a plurality of communication channels. Communications on the plurality of communication channels are delivered based upon, at least in part, the communications management policy. Similarly, communications on the plurality of communication channels are rejected based upon, at least in part, the communications management policy.

One or more of the following features may be included. The plurality of communications channels include one or more of email, instant messaging, voice communication, and SMS communications. Additionally, the communication management policy is defined by a third party.

The communication management policy may be based upon, at least in part, one or more of an organizational structure, and a social network defined for a user. The communication management policy may include a plurality of levels of communication permissions. The communication management policy may be based upon, at least in part, one or more of a time-wise schedule, and a volume for the plurality of communication channels.

The computer program product may also include instructions for defining one or more exceptions to the communication management policy. Furthermore, the computer program product may include instructions for notifying a communication sender of a rejected communication.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a communication management process and an email application coupled to a communication network.

FIG. 2 is a flowchart of a process executed by the communication management process of FIG. 1.

FIG. 3 is a display screen rendered by the communication management process of FIG. 1.

FIG. 4 is a diagrammatic view of an organizational structure that may be referenced by the communication management process of FIG. 1.

### DETAILED DESCRIPTION OF THE PREFERRED EMBODIMENTS

### System Overview:

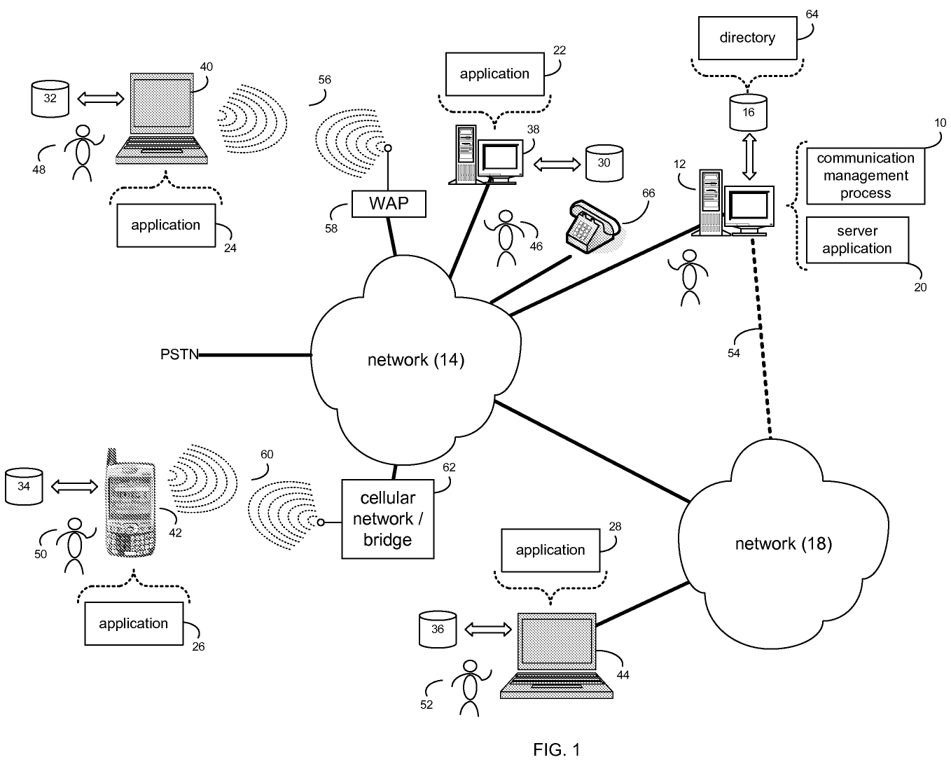

Referring to FIG. 1, there is shown communication management process 10 that may reside on and may be executed by server computer 12, which may be connected to network 14 (e.g., a communication network, which may include the Internet, a local area network, a telephone network, or other communication network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example. Alternatively, communication management process 10 may reside on and be executed, in whole or in part, by a client electronic device, such as a personal computer, notebook computer, personal digital assistant, or the like.

As will be discussed below in greater detail, communication management process 10 may allow a communication management policy to be defined. Communications to a user may be delivered or rejected based upon, at least in part, the communication management policy. The communication management policy may be applied to a plurality of communications channels including, but not limited to, email, instant messaging, voice communication, text messaging (short message service, SMS, communications), and the like. Communication management process 10 may limit and/or control interruptions as a result of the allowed and rejected communications.

The instruction sets and subroutines of communication management process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; an intranet; or other communication network (e.g., telephone network, or the like), for example.

Server computer 12 may execute one or more server application, e.g., server application 20. Examples of server application 20 may include, but are not limited to, email server applications (e.g., Lotus Domino™ Server and Microsoft Exchange™ Server), instant messaging server applications (e.g., IBM Lotus Sametime™, Microsoft Office Live Communications Server™, Jabber XCP™, and AOL Instant Messenger™), voice over IP server applications or PBX telephone systems, and text messaging application (short message service applications). Server application 20 may interact with client applications 22, 24, 26, 28, examples of which may include, but are not limited to, email client applications that may include calendar and/or scheduling modules (e.g., Lotus Notes™ and Microsoft Outlook™), instant messaging client applications (e.g., AOL Instant Messenger™, IBM Lotus Sametime™, Google Talk™), voice over IP client applications, softphone applications, smart answering machine, text messaging (short message service) client applications. Communication control process 10 may be a stand alone application that interfaces with server application 20 or may be an applet/application that is executed within server application 20. Additionally, while not shown, server application 20 and communication management process 10 may reside on different servers coupled to network 14, 18. Similarly, various applications of the one or more server applications (of which server application 20 is an example) may reside on different servers coupled to network 14, 18.

The instruction sets and subroutines of server application 20, which may be stored on storage device 16 coupled to server computer 12 may be executed by one or more processors (not shown) and one or more memory architectures (not shown) incorporated into server computer 12.

As mentioned above, in addition/as an alternative to being a server-based application residing on server computer 12, the communication management process may be a client-side application (not shown) residing on one or more storage device (e.g., stored on storage device 30, 32, 34, 36) coupled to one or more client electronic device (e.g., client electronic devices 38, 40, 42, 44, respectively). As such, the communication management process may be a stand alone application that interfaces with an application (e.g., client applications 22, 24, 26, 28), or may be an applet/application that is executed within an application (e.g., client applications 22, 24, 26, 28). As such, the communication management process may be a client-side process, a server-based process, or a hybrid client-side/server-based process, which may be executed, in whole or in part, by server computer 12, or one or more of client electronic device 38, 40, 42, 44.

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and a memory stick storage devices. Examples of client electronic devices devices 38, 40, 42, 44 may include, but are not limited to, personal computer 38, laptop computer 40, personal digital assistant 42. notebook computer 44, a data-enabled, cellular telephone (not shown), and a dedicated network device (not shown), for example. Using client applications 22, 24, 26, 28, users 46, 48, 50, 52 may, for example, access server application 20 and may, e.g., conduct email communications, schedule/manage calendar events, conduct instant messaging communications, conduct voice communications, browse the internet, and the like.

Users 46, 48, 50, 52 may access server application 20 directly through the device on which the client application (e.g., client applications 22, 24, 26, 28) is executed, namely client electronic devices 38, 40, 42, 44, for example. Additionally, one or more user (e.g., user 46 in the illustrated embodiment) may access server application 20 (e.g., which may be a PBX system, or provide a gateway to a PBX system) through telephone 66. Users 46, 48, 50, 52 may access server application 20 directly through network 14 or through secondary network 18. Users 46, 48, 50, 52 may access server application 20 directly through network 14 or through secondary network 18. Further, server computer 12 (i.e., the computer that server application 20) may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Telephone 66 may be directly coupled to network 14 (e.g., which may include a telephone network, such as a PBX network, for example). Additionally, network 14 (which may include a telephone network) may couple server computer 12, executing server application 20 (which may include a PBX gateway or a PBX system) to a public switched telephone network (PSTN) or similar telephone system.

Client electronic devices 38, 40, 42, 44 may each execute an operating system, examples of which may include but are not limited to Microsoft Windows™, Microsoft Windows CE™, Redhat Linux™, or a custom operating system.

### The Communication Management Process:

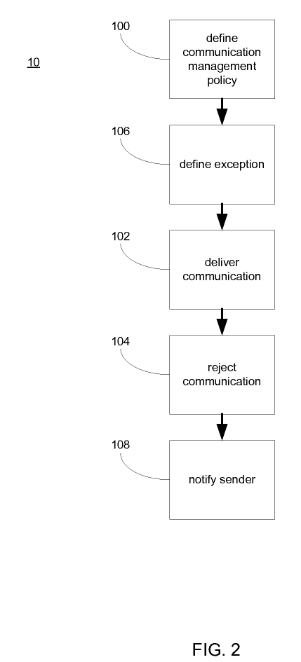

Referring also to FIG. 2, communication management process 10 may allow a user to define 100 a communication management policy for a plurality of communication channels. Communication management process 10 may deliver 102 communications to the user based upon, at least in part, the communication management policy. Communication management process 10 may also reject 104 communications to the user based upon, at least in part, the communication management policy. In this manner, communication management process 10 may reduce and/or eliminate the interruptions that a user experiences from incoming communications.

For example, user 46 may define 100 a communication management policy for the various communication channels, which may be provided by one or more communication applications (e.g., generally indicated by application 22). The communication applications may include, for example, email, instant messaging voice communication (e.g., voice over IP, PBX), text messaging (i.e., short message service messaging), or the like. For the convenience of description, only application 22 is shown in FIG. 1. Additionally/alternatively, a third party (e.g., a supervisor, system administrator, or the like) may define 100 the communication management policy for user 46.

The communication management policy may determine conditions under which user 46 may receive communications. The communication management policy may determine other users from whom user 46 may receive communications on the various communication channels (e.g., email, instant messages, voice calls, text messages, and the like). As mentioned above, the communication management policy may be defined by user 46. Additionally/alternatively, the communication management policy may be defined 100 by a third party, may be based on one or more system wide policies, or may bed defined using various other methods or arrangements.

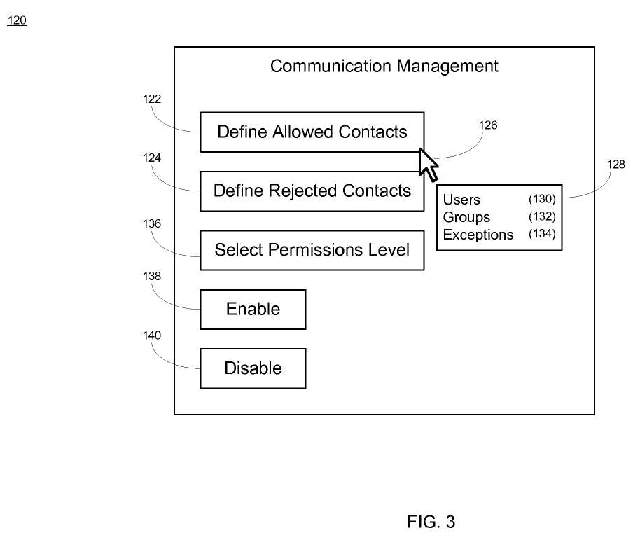

For example, and referring also to FIG. 3, communication management process 10 may allow user 46 to define 100 the communication management policy, for example, using communication management user interface 120, e.g., rendered by communication management process 10. As shown, communication management user interface 120 may include, but is not limited to, “Define Allowed Contacts” button 122 and “Define Rejected Contacts” button 124.

User 46 may select “Define Allowed Contacts” button 122, e.g., using onscreen pointer 126 controlled by a pointing device (e.g., a mouse; not shown) to define users having communication permissions. Selecting “Define Allowed Contacts” button 122 may result in communication management process 10 rendering popup 128 that may define a plurality of options allowing user 46 to define allowed contacts in communication management policy. As shown, popup 128 may include options such as users 130, groups 132, and exceptions 134. By selecting (e.g. using onscreen pointer 126 controlled by the pointing device) users 130, user 46 may define (e.g., via additional popup windows or the like) specific users from whom communication may be allowed. Similarly, by selecting groups 132, user 46 may define groups of users from whom communications may be allowed. Additionally, by selecting exceptions 134, user 46 may define users outside of a general communication management policy from whom communications are allowed.

User 46 may similarly define 100 the communication management policy to include users from whom communications are rejected, e.g., defining users that do not have communication permissions. For example, user 46 may select “Define Rejected Contacts” button 124. Using an associated series of popup windows, or the like (e.g., as described with reference to defining users having communication permissions), user 46 may define users, groups, exceptions, and so on, that do not have communication permissions.

The defined 100 communication management policy may determine that user 46 may receive communications from users 48 and 52, but not from user 50. The communication management policy may be applied to all forms of communication uniformly (e.g., the communication management policy may be applied to email, instant messaging, voice communications, and text messaging). In another embodiment, the communication management policy may be applied to only some of the available communication channels (e.g., to email and instant messaging, but not voice communication or text messaging). Furthermore, the communication management policy may define different communication permissions (e.g., users from who user 46 may receive communications) for different communication channels.

Communication management process 10 may deliver 102 communications from senders having communication permissions defined by the communication management policy. Continuing with the above-stated example, the communication management policy may determine that users 48 and 52 have communication permissions for user 46. Therefore, communication management process 10 may deliver 102 communications from users 48 and 52 to user 46. Similarly, in the above-stated example, user 50 may not have communication permissions for user 46. Communication management process 10 may, therefore, reject 104 communications to user 46 sent by user 50.

Communication management process 10 may reject 104 communications to user 46, for example, by not transferring communications to application 22 (e.g., in the case of email, instant messaging, and the like in which application 22 may be a client communication application). For example, communication management process 10 may interact with (e.g., issue a command to) server application 20 to reject 104 communications to user 46. Similarly, communication management process 10 may reject 104 SMS communications, for example, by forwarding SMS messages to a control point (e.g., a data store, in which the SMS message may be saved, e.g., for later delivery). Rejecting 104 SMS communications may include, for example, transmitting a request to a mobile phone operator (or other operator responsible for handling routing and delivery of SMS messages) to forward SMS messages for user 46 to the control point. Similarly, rejecting 104 telephone communications, e.g., on a PSTN, may include, for example, transmitting a request to a PSTN telephone provider to forward telephone calls of user 46 to a control point (e.g., which may include a telephone answering system, such as a voicemail system). Further, rejecting 104 PBX based voice communications may include, for example, transmitting a request to a PBX control system (e.g., which may include server application 20) to forward telephone calls for user 46 to a control point (e.g., which may include a telephone answering system, such as a voicemail system). Various other mechanisms may be employed for rejecting 104 SMS, telephone, and other communications.

Communications rejected 104 by communication management process 10 may be delivered 102 at a later time. For example, communication management process 10 may store/queue rejected 104 communications. Based upon, at least in part, the communication management policy, communication management process 10 may deliver 102 the stored/queued communications to user 46 within a predetermined time period (e.g., at the end of the work day, before the beginning of the next work day, at predetermined intervals, when communication management process 10 is inactive, or based upon various other criteria).

The communication management policy defined 100 for user 46 may be based upon a variety of factors. As mentioned above, communication management process 10 may reduce interruptions experienced by user 46. The communication management policy defined 100 for user 46 may, therefore, reject 104 communications from users that are less likely to be of importance to user 46, while still delivering 102 communications from users that are more likely to be of importance to user 46.

The communication management policy may be based upon, at least in part an organizational structure. Continuing with the above-stated example, user 46 may be an employee of a company. Based upon the defined 100 communication policy, communication management process 10 may deliver 102 or reject 104 communications to user 46 based upon, at least in part, the position of the sender relative to user 46. The organizational structure of the company may be known, for example, from corporate directory 64, which may reside in a database on server computer 12.

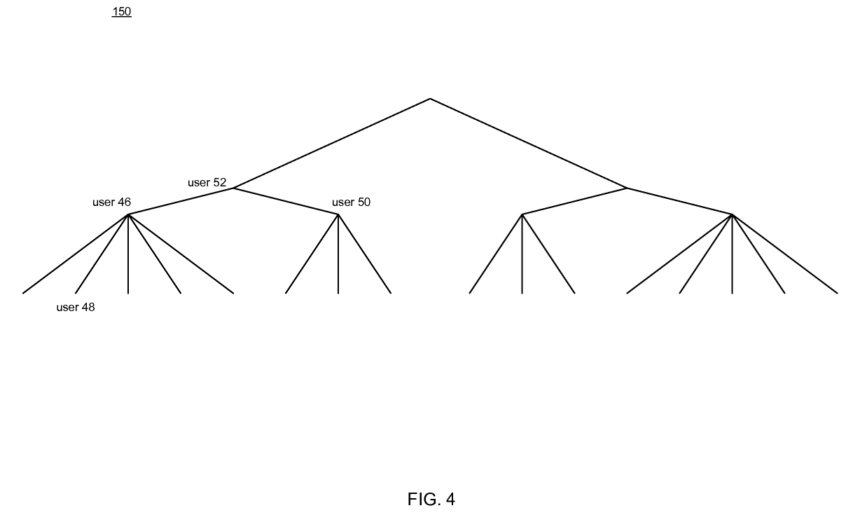

Referring also to FIG. 4, a tree diagram of an organizational structure 150 (e.g., as defined in corporate directory 64) may indicate the relative positions of users 46, 48, 50, 52 within the organizational structure. As shown, user 46 may be user 48's direct supervisor, and user 52 may be user 46's direct supervisor. User 50 may belong to a different department than users 46, 48.

It may be anticipated that communications from people within a user's own department and from the user's immediate supervisor may generally be of greater importance than communications from people in other departments. Continuing with the above-stated example, the communication management policy may determine that users 48, 52 (e.g., a member of user 46's department and user 46's immediate supervisor, respectively) have communication permissions for user 46. Communications from users 48, 52 may be delivered 102 to user 46. Correspondingly, the communication management policy may determine that user 50 (e.g., a user in a different department) does not have communication permissions for user 46. Communication management process 10 may, therefore, reject 104 communications from user 50 to user 46.

The relative position of users 46, 48, 50, 52 in organizational structure 150 may be determined based on degrees of separation. For example, users 48 may be immediately below user 46 in organizational structure 150, and user 52 may be immediately above user 46 in organizational structure 150. Users 48, 52 may each have a degree of separation of one (e.g., −1 and +1 respectively). User 50, in a different department, may have a degree of separation greater than one. Communication management process 10 may allow the communication management policy to be defined 100 using a degree of separation other than one in various applications.

In addition/as an alternative to being based upon, at least in part, organizational structure, the communication management policy defined 100 for the user may be based upon, at least in part, a social network defined for a user. The user's social network may be defined by a variety interactions between the user and others. Such interactions may include, but are not limited to, a history of communications across various communication channels, inclusion on the user's instant messaging buddy list, attendance at the same meetings (e.g., as indicated by commonly scheduled events in respective calendaring applications, which may be included as modules of an email application), working together on the same projects, and so on.

Continuing with the above stated example, user 46 may repeatedly exchange email and instant messages with user 48. Additionally, user 46 may repeatedly engage in voice communications with user 52. Based on the repeated interactions, users 48 and 52 may be determined to be within user 46's social network. The communication management policy may be defined 100 to grant communication permissions to users 48, 52 based upon, at least in part, inclusion within user 46's social network. As noted above, user 46's social network may additionally/alternatively be based upon additional interactions and/or attributes.

The communication management policy may include a plurality of levels of communication permissions. For example, the communication management policy may include a first, a second, and a third level of communication permissions. The levels of communication permissions may, for example, provide increasing breadth in the users having communication permissions. Continuing with the example of a first, a second, and a third level of communication permissions, the first level of communication permissions may grant communication permission to the smallest number of users, and the second and third levels of communication permissions may grant communication permission to an increasing number of users. The communication management policy may include various numbers of levels having various degrees of granularity.

The level of communication permissions included in the communication management policy may be selected (e.g., by selecting “Select Permissions Level” button 136 in communications management user interface 120) to provide a desired level of interruption in a given situation. For example, in a situation in which the fewest interruptions are desired (e.g., in which the fewest communication permissions are granted) the first level of communication permissions may be selected. When the user is willing to tolerate a slightly greater number of interruptions, the second level of communication permissions may be selected. The second level of communication permissions may grant communication permission to all of the users included in the first level of communication permissions, as well as granting communication permissions to additional users. When the user is willing to experience an even greater number of interruptions, the third level of communication permissions (which may grant permission to all of the users in the first and second levels of communication permissions, as well as granting communication permissions to additional user) may be selected.

In the above-stated example in which the communication management policy may be based upon, at least in part, degree of separation in an organizational structure, the communication management policy may include a plurality of levels corresponding to degrees of separation in the organizational structure. For example, a first level of communication permissions may grant communication permission to all users within one degree of separation. A second level of communication permissions may grant communication permissions to all users within two degrees of separation. Various other level divisions may also be used.

In a similar manner, and referring to the above-stated example in which the communication management policy may be based upon, at least in part, a user's social network, the communication management policy may include a plurality of levels corresponding to frequency or strength of the interactions upon which the social network is based. For example, the people with whom the user most frequently communicates, with whom the user has most recently communicated, and/or with whom the user communicates over the greatest number of communication channels, may occupy a first level of communication permissions. A second level of communication permissions may grant communication permission to people with whom the user less frequently communicates, has less recently communicated with, or communicates with over a fewer number of communication channels. The second level of communication permissions may also grant communication permission to those people included in the first level of communication permissions.

Communication management process 10 may apply the communication management policy (or various selected levels of communication permissions) based upon one or more criteria. For example, communication management process 10 may apply the communication management policy (or selected levels of communication permissions) based upon a user selection (e.g., by selecting “Select Permissions Level” button 136, “Enable” button 138, or “Disable” button 140 in communication management user interface 120). For example, user 46 may activate communication management process 10 (e.g., by selecting “Enable” button 138) and/or select a desired communication management policy and/or a selected level of communication permissions (e.g., by selecting “Select Permissions Level” button 136).

Additionally/alternatively, the communication management policy (or various selected levels of communication permissions) may be based upon, at least in part, a time-wise schedule. For example, user 46 may wish to dedicate the morning to specific projects, while using the afternoon to address correspondences and administrative matters. In such a situation, user 46 may define 100 a communication management policy that provides relatively restrictive communication permissions in the morning (e.g., during a predetermined time period in the morning), and may provide relatively unrestricted communication permissions in the afternoon (e.g., during a predetermined time period in the afternoon). Based upon, at least in part, the communication management policy, communication management process 10 may reject 104 the majority of communications to user 46 (e.g., may only deliver 102 communications from those individuals within one degree of separation from user 46) during the predetermined time period in the morning. Correspondingly, based upon, at least in part, the communication management policy, communication management process 10 may deliver all communications (including communications rejected during the predetermined time period in the morning) during the predetermined time period in the afternoon.

Additionally/alternatively, the communication management policy may be based upon, at least in part, a communication volume of the plurality of communication channels. For example, the level of communication permissions may vary according to incoming communication volume across the plurality of communication channels. When communication volume is high, more restrictive communication permissions may be implemented. The more restrictive communication permissions may reduce the interruptions experienced by user 46. When communication volume is relatively low, less restrictive communication permissions may be implemented because the low volume of communications may, by itself, provide a low level of interruptions. As such, communication management process 10 may deliver 102 a higher percentage of communications to user 46, but the number of communications delivered 102 to user 46 may remain generally constant. The threshold volume of communications may be selected by user 46, e.g., when user 46 defines 100 the communication management policy.

Communication management process 10 may also allow user 46 to define 106 one or more exceptions to the communication management policy (e.g., by selecting “Exceptions” 134 in popup 128). Continuing with the above-stated example in which the defined 100 communication management policy may provide communication permissions for users within one degree of separation from user 46 (i.e., users 48, 52), communication management process 10 may allow user 46 to define 106 an exception to the communication management policy (e.g., to grant communication permissions to a user that is not within one degree of separation of user 46). For example, user 46 may be collaborating with user 50 on a project. User 46 may, therefore, wish to receive communications from user 50, having more than one degree of separation from user 46. Communication management process 10 may allow user 46 to define an exception to the communication management policy to grant communication permissions to user 50. In such a situation, notwithstanding the communication management policy granting communication permission to users within one degree of separation to user 46, user 50 may be granted communication permissions.

In addition to defining 106 individual exceptions to the communication management policy, user 46 may be allowed to define 106 exceptions to the communication management policy for groups of users (e.g., other departments, all managers defined in corporate directory 64, and similar groups). Additionally, user 46 may define 106 an exception based on a characteristic of the communication, such as urgency, subject line, or other characteristic. Communication management process 10 may, therefore, allow user 46 to define 100 a general communication management policy and also define 106 exceptions to the general communication management policy to grant communication permissions to users, groups of users, or communications outside of the general communication management policy.

As discussed with reference to specific examples, the various settings, permissions, levels, and attributes of the communication management policy may be defined 100 by user 46 using communication management user interface 120. As also mentioned, various other mechanisms may be used for defining 100 the communication management policy. For example, the communication management policy may be defined 100, at least in part, by a third party (e.g., who may or may not use communication management user interface 120). Additionally, the communication management policy may be defined 100 based upon one or more system wide, group specific, or user specific rules or policies. Various other mechanisms may also be employed.

Communication management process 10 may notify 108 senders of communications that are rejected 104 that the communication has not been (at least immediately) received by user 46. Notifying 108 the sender of a rejected 104 communication may avoid situation in which the sender may be awaiting a response to a communication that was not (at least immediately) received by user 46. For example, if an immediate response is necessary, when the sender is notified 108 that the communication was not (at least immediately) received by user 46, the sender may attempt to contact user 46 by other means in order to handle the matter.

Communication management process 10 may notify 108 senders of rejected 104 communications in a variety of ways. For example, an automated email response may be provided to the sender of a rejected 104 email. An online, but unavailable user interface semantic may be provided in an instant messaging application of users without communication permissions. An automated response may be provided during an attempted voice communication by a user without communication permissions. Various additional/alternative notifications may be used.

A number of implementations have been described. Nevertheless, it will be understood that various modifications may be made. Accordingly, other implementations are within the scope of the following claims.

What is claimed is:

1. A method comprising:
defining a communication management policy for a plurality of communication channels;
delivering communications on the plurality of communication channels based upon, at least in part, the communications management policy; and
rejecting communications on the plurality of communication channels based upon, at least in part, the communications management policy.

2. The method of claim 1, wherein the plurality of communications channels include one or more of email, instant messaging, voice communication, and SMS communications.

3. The method of claim 1, wherein the communication management policy is defined by a third party.

4. The method of claim 1, wherein the communication management policy is based upon, at least in part, an organizational structure.

5. The method of claim 1, wherein the communication management policy is based upon, at least in part, a social network defined for a user.

6. The method of claim 1, wherein the communication management policy includes a plurality of levels of communication permissions.

7. The method of claim 1, wherein the communication management policy is based upon, at least in part, a time-wise schedule.

8. The method of claim 1, wherein the communication management policy is based upon, at least in part, communication volume for the plurality of communication channels.

9. The method of claim 1, further including defining one or more exceptions to the communication management policy.

10. The method of claim 1, further including notifying a communication sender of a rejected communication.

11. A computer program product residing on a computer readable medium having a plurality of instructions stored thereon which, when executed by a processor, cause the processor to perform operations comprising:
defining a communication management policy for a plurality of communication channels;
delivering communications on the plurality of communication channels based upon, at least in part, the communications management policy; and
rejecting communications on the plurality of communication channels based upon, at least in part, the communications management policy.

12. The computer program product of claim 11, wherein the plurality of communications channels include one or more of email, instant messaging, voice communication, and SMS communications.

13. The computer program product of claim 11, wherein the communication management policy is defined by a third party.

14. The computer program product of claim 11, wherein the communication management policy is based upon, at least in part, an organizational structure.

15. The computer program product of claim 11, wherein the communication management policy is based upon, at least in part, a social network defined for a user.

16. The computer program product of claim 11, wherein the communication management policy includes a plurality of levels of communication permissions.

17. The computer program product of claim 11, wherein the communication management policy is based upon, at least in part, a time-wise schedule.

18. The computer program product of claim 11, wherein the communication management policy is based upon, at least in part, communication volume for the plurality of communication channels.

19. The computer program product of claim 11, further including instructions for defining one or more exceptions to the communication management policy.

20. The computer program product of claim 11, further including instructions for notifying a communication sender of a rejected communication.
